(19) United States
(12) Patent Application Publication
(10) Pub. No.: US 2017/0297414 A1
(43) Pub. Date: Oct. 19, 2017

(54) A SYSTEM FOR USE IN A VEHICLE

(71) Applicant: JAGUAR LAND ROVER LIMITED, Warwickshire (GB)

(72) Inventor: Neil BELOE, Whitley, Coventry, Warwickshire (GB)

(21) Appl. No.: 15/502,922

(22) PCT Filed: Aug. 4, 2015
(86) PCT No.: PCT/EP2015/067935

§ 371 Date: Feb. 9, 2017

(30) Foreign Application Priority Data
Aug. 11, 2014 (GB) 1414201.2

(51) Int. Cl. B60H 1/00; B60H 1/02; B60H 1/32

(52) U.S. Cl. CPC B60H 1/00899; B60H 1/025; B60H 1/00735; B60H 1/323; B60H 1/00492; B60H 1/00885; B60H 2001/00928; B60H 2001/00949

(57) ABSTRACT

A vehicle arrangement (20) for thawing thermal energy from and/or rejecting thermal energy to a plurality of components in a vehicle, the arrangement comprising a heat-pump assembly (12) comprising a first heat-pump section (18) at a first temperature and a second heat-pump section (22) at a second temperature different from the first temperature, and a first thermal energy distribution path (26) for transporting a first carrier fluid and extending through at least a portion of the first heat-pump section (18), and a second thermal energy distribution path (28) for transporting a second carrier fluid and extending through at least a portion of the second heat-pump section (22). The arrangement further comprises a first circulation pump (32) associated with the first thermal energy distribution path (26) for pumping the first carrier fluid around the first thermal energy distribution path and a second circulation pump (34) associated with the second thermal energy distribution path (28) for pumping the second carrier fluid around the second thermal energy distribution path. In addition the system comprises means (78-100) for selectively connecting at least one of the plurality of vehicle components to at least one of the thermal energy distribution paths so as to draw thermal energy from and/or reject thermal energy to said vehicle component or components.

### TECHNICAL FIELD

The present invention relates to a vehicle arrangement and in particular to a vehicle arrangement that enables thermal energy to be collected and distributed between a plurality of vehicle components. Aspects of the invention relate to a vehicle arrangement, a vehicle system, a method for use in a vehicle, and to a vehicle itself.

### BACKGROUND

A conventional internal combustion engine (ICE) in a motor vehicle generates a large amount of “waste” heat (thermal energy) while in operation. This high-temperature thermal energy must be dissipated from the engine to prevent damage to the engine materials and lubricants. One way in which this is done is by running a carrier fluid or coolant through the engine to absorb some of the heat. The carrier fluid is commonly a mixture of water and an antifreeze liquid such as ethylene glycol. In particular, carrier fluid may be pumped through channels in the engine block and then through a radiator (heat exchanger). The radiator is commonly positioned behind the grill at the front of the vehicle. When the vehicle is in motion, cool air flows over and around the radiator pipes containing the carrier fluid and thus thermal energy in the carrier fluid is transferred to the surroundings.

Rather than simply dissipating the thermal energy generated in the engine to the surroundings, some of the energy is commonly used to heat the vehicle cabin. In this case, some of the high-temperature carrier fluid that exits the engine block may be diverted through a radiator comprising a series of conductive pipes located under the vehicle dashboard. A fan located adjacent the radiator directs an airflow over and around the radiator towards the vehicle cabin; the air absorbs thermal energy from the high-temperature carrier fluid in the conductive piping and then enters the vehicle cabin.

However, as the efficiency of ICEs increases with the advancement of technology there is less thermal energy generated, and therefore less waste energy available to heat the vehicle cabin. In this case a heat-pump assembly comprising a heat-pump cycle, or heat-pump path, may be utilised to make best use of the available thermal energy. In particular, carrier fluid exiting the engine block flows into a first heat exchanger, specifically an evaporator, and thermal energy is transferred to a second fluid flowing through the evaporator. This second fluid, or refrigerant, may be R143a or R1234yf. The thermal energy absorbed by the refrigerant causes it to change to a gaseous state. This gas then flows through a compressor, which increases its pressure and temperature, before flowing into a second heat exchanger, specifically a condenser. A fan located adjacent the condenser then causes an airflow through the condenser; the air absorbs thermal energy from the high-temperature gaseous refrigerant and enters the vehicle cabin. The high-pressure refrigerant reverts to a liquid state and then flows through an expansion valve where its pressure is lowered before being returned to the evaporator for the cycle to be repeated. Typically the evaporator, compressor and expansion valve are located in the engine unit and the condenser is located in the passenger compartment.

A vehicle air-conditioning system designed to cool, rather than to heat, the vehicle cabin also uses a heat-pump cycle comprising the components described above; however, in this case the condenser, compressor and expansion valve are located in the engine unit and the evaporator is located in the passenger compartment to draw warm air from, and blow cooler air into, the vehicle cabin.

In both of the above-described systems, refrigerant flows to the passenger compartment. Use of refrigerant R134a is being phased out because of its adverse effect on the environment (in particular, its global warming-related properties), and the proposed alternative, namely refrigerant R1234yf, is flammable. Hence it is desirable that the refrigeration cycle is in a confined region.

It is known in the prior art to house a heat-pump assembly with a heat-pump cycle in a confined unit, and to pump carrier fluid into and out of the unit, where carrier fluid in a first thermal energy distribution path passes through the passenger compartment and carrier fluid in a second thermal energy distribution path passes through the engine unit. The carrier fluid in one of these paths is at a first “cold” temperature and the carrier fluid in the other path is at a second “hot” temperature. The temperature of the carrier fluid in a given thermal energy distribution path may be changed from hot to cold, or vice versa, via actuation of the heat pump. This type of arrangement is known as a reversible heat pump. The vehicle cabin may therefore be cooled or heated as desired and the vehicle engine may, for example, be cooled during operation or heated during start-up.

A reversible heat pump has the disadvantage that it does not comprise a dedicated condenser and a dedicated evaporator; rather it comprises two heat exchangers, both of which must function as either a condenser or an evaporator depending on the direction of flow within the heat-pump cycle. This means that the design of the heat exchangers is compromised such that they are not optimised to perform either function and are therefore less efficient. Another disadvantage is that, so as to allow actuation of the heat-pump cycle, the reversible heat pump cannot be hermetically sealed, thereby exposing areas from which refrigerant can leak from the system via the actuation mechanism. A further disadvantage is that the need to reverse the refrigerant flow at high pressure adds complexity and expense to the arrangement.

In an electric or hybrid electric vehicle, there is even less waste thermal energy generated than in a conventional ICE; for example, a typical ICE operates at around 80 degrees Celsius but a typical electric engine operates at 30-50 degrees Celsius. In addition, such vehicles (and indeed ICE vehicles) have additional components that may need heating and/or cooling, such as a battery pack, gearbox or electronics unit, placing an even greater burden on the available thermal energy. It is known in the prior art to provide a system with a fixed hot path and a fixed cold path as described above, whereby a number of components may be connected in series in a particular path. “Fixed” means that any given component may be “switched into” or “switched out of” the particular path of which it is part as and when needed by utilising a number of bypass paths. However, the above-described system suffers the disadvantage that individual components cannot individually be switched from one path to the other. Also, this system has no provision for different components needing different levels of heating. In addition, the carrier fluid in a given path may dissipate the majority of its heat, for example, to the first component it traverses, leaving little heat to be dissipated to the other components in the remainder of the path. Further, a complex network of valves and bypass pipes is needed to allow components to be switched into or out of a path. In any case, as intimated above, an electric engine tends not to generate enough thermal energy to satisfy the demands of a modern vehicle.

It is an aim of the present invention to address the disadvantages in the prior art and the issues outlined above, and to provide a solution that is both adaptable and that makes maximum use of the thermal energy produced by the various components of a vehicle in the most convenient and efficient way.

### STATEMENTS OF INVENTION

According to one aspect of the invention there is provided a vehicle arrangement for drawing thermal energy from and/or rejecting thermal energy to a plurality of components in a vehicle, the arrangement comprising a heat-pump assembly comprising a first heat-pump section at a first temperature and a second heat-pump section at a second temperature different from the first temperature. The vehicle arrangement further comprises a first thermal energy distribution path for transporting a first carrier fluid and extending through at least a portion of the first heat-pump section, and a second thermal energy distribution path for transporting a second carrier fluid and extending through at least a portion of the second heat-pump section. In addition there is provided a first circulation pump associated with the first thermal energy distribution path for pumping the first carrier fluid around the first thermal energy distribution path, and a second circulation pump associated with the second thermal energy distribution path for pumping the second carrier fluid around the second thermal energy distribution path. Also provided is means for selectively connecting at least one of the plurality of vehicle components to at least one of the thermal energy distribution paths so as to draw thermal energy from and/or reject thermal energy to said vehicle component or components.

It will be recognised that a vehicle arrangement may also be described as a vehicle system.

Selective switching of each vehicle component in or out of a thermal distribution path to be heated or cooled, as needed, is advantageous because it means that the available thermal energy is used more efficiently. Thermal energy may be collected from one or more components as and when it is available and may be distributed to one or more other vehicle components as and when it is needed. In this way the vehicle arrangement is adaptable and the inefficiency of vehicle components is capitalised on. This is of particular use in electric or hybrid electric vehicles, where there is generally less heat generated by the engine that is suitable for distribution to other vehicle components.

The first heat-pump section may comprise a dedicated evaporator and the second heat-pump section may comprise a dedicated condenser. A dedicated heat exchanger, for example a dedicated evaporator or dedicated condenser, needs to perform one function only and so may be designed to optimise performance of said function, thus resulting in improved efficiency over a system comprising heat exchangers that are configured to perform a plurality of functions (such as, for example, evaporating and condensing).

The heat-pump assembly may further comprise a third heat-pump section at a third temperature different from the first and second temperatures. In addition there is provided a third thermal energy distribution path for transporting a third carrier fluid and extending through at least a portion of the third heat-pump section, and a third circulation pump associated with the third thermal energy distribution path for pumping the third carrier fluid round the third thermal energy distribution path.

This allows vehicle components that need different levels of heating to be switched into different thermal energy distribution paths, thus further improving the efficiency of use of the available thermal energy. Also, this means that thermal energy may be collected from one or more vehicle components via one thermal energy distribution path while simultaneously being distributed to one or more other vehicle components via another thermal energy distribution path. Further thermal energy distribution paths may also be useful.

The third heat-pump section may comprise a dedicated condenser. The heat-pump assembly may comprise a heat-pump path for transporting a refrigerant fluid, wherein the heat-pump path extends through the heat-pump sections.

In one embodiment the heat-pump assembly further comprises an accumulator for storing thermal energy. Alternatively, or in addition, the heat-pump assembly may include an intermediate heat exchanger or other performance enhancing device.

The heat-pump assembly may be hermetically sealed. Unlike in a reversible heat-pump assembly where access to an actuator within the assembly to reverse the direction of flow is needed, no such access is needed in the present unidirectional flow assembly, thus removing a potential source of leakage of, for example, refrigerant fluid.

The means for selectively connecting at least one of the plurality of vehicle components to at least one of the thermal energy distribution paths includes at least one valve device, where the at least one valve device may be a hydraulic valve device. The at least one valve device may be an on/off control valve. Alternatively the at least one valve device may be a six-port valve for selectively connecting a vehicle component to one of two of the thermal energy distribution paths.

The at least one valve device may be a variable valve device for allowing only a proportion of the flow in one of the thermal energy distribution paths to traverse at least one vehicle component. This may be advantageous for rejecting only a required amount of the available thermal energy to a given component, or for ensuring that the thermal energy to a plurality of components that are switched in to a particular thermal energy distribution path is distributed in a particular way.

In one embodiment, at least one thermal energy distribution path is for transporting a different carrier fluid from at least one other thermal energy distribution path. Unlike in a reversible heat-pump assembly, each thermal energy distribution path does not need to transport carrier fluid at a wide range of temperatures. In the present unidirectional flow case, each thermal energy path may transport a carrier fluid that optimises energy efficiency at the controlled narrow range of fluid temperatures particular to a given path.

At least one thermal energy distribution path may comprise a feed line and a return line. According to another aspect of the invention there is provided a system for controlling the vehicle arrangement described above, the system comprising means configured to receive sensor output data from at least one vehicle sensor and means configured to store pre-determined data relating sensor output data from the at least one vehicle sensor to a particular configuration of the vehicle arrangement. The system further comprises means configured to compare the sensor output data with the pre-determined data, and means configured to send at least one control signal to actuate the means for selectively connecting at least one of the plurality of vehicle components to at least one of the thermal energy distribution paths, and/or to actuate at least one of the circulation pumps, in dependence on said comparison.

The at least one vehicle sensor may be a vehicle component temperature sensor or a heat-pump assembly temperature sensor.

According to an aspect of the present invention there is provided a method for controlling the vehicle arrangement described above, the method comprising receiving sensor output data from at least one vehicle sensor and storing pre-determined data relating sensor output data from the at least one vehicle sensor to a particular configuration of the vehicle arrangement. The method further comprises comparing the sensor output data with the pre-determined data, and sending at least one control signal to actuate the means for selectively connecting at least one of the plurality of vehicle components to at least one of the thermal energy distribution paths, and/or to actuate at least one of the circulation pumps, in dependence on said comparison.

According to a further aspect of the invention there is provided a data memory containing a computer readable code for performing the method according to the method described above.

According to a further aspect of the invention there is provided a vehicle comprising the vehicle arrangement described above. There is also provided a vehicle comprising the system described above.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. For example, features disclosed in connection with one embodiment are applicable to all embodiments, except where such features are incompatible.

### BRIEF DESCRIPTION OF DRAWINGS

The invention will now be described, by way of example only, with reference to the accompanying figures in which:

FIG. 1 is a diagram showing a vehicle thermal energy distribution arrangement (VTEDA) according to one embodiment of the invention, the arrangement comprising a heat-pump assembly with a unidirectional heat-pump path; a plurality of vehicle components; and thermal energy distribution paths between the heat-pump path and vehicle components;

FIG. 2 is a schematic diagram of the three possible configurations of the six-port valves in FIG. 1;

FIG. 3 is a diagram showing the component parts of a vehicle control system (VCS) for controlling the VTEDA in FIG. 1, together with the inputs to, and outputs from, the VCS; and

FIG. 4 is a diagram showing a VTEDA according to another embodiment of the invention.

### DETAILED DESCRIPTION

The present invention capitalises on the inefficiency of vehicle components by collecting waste thermal energy from one or more of said vehicle components, storing said thermal energy, and distributing said thermal energy to one or more vehicle components that need heating or cooling. The invention is suitable for use in a vehicle with a conventional internal combustion engine (ICE), but is also particularly suitable for use in an electric or hybrid electric vehicle.

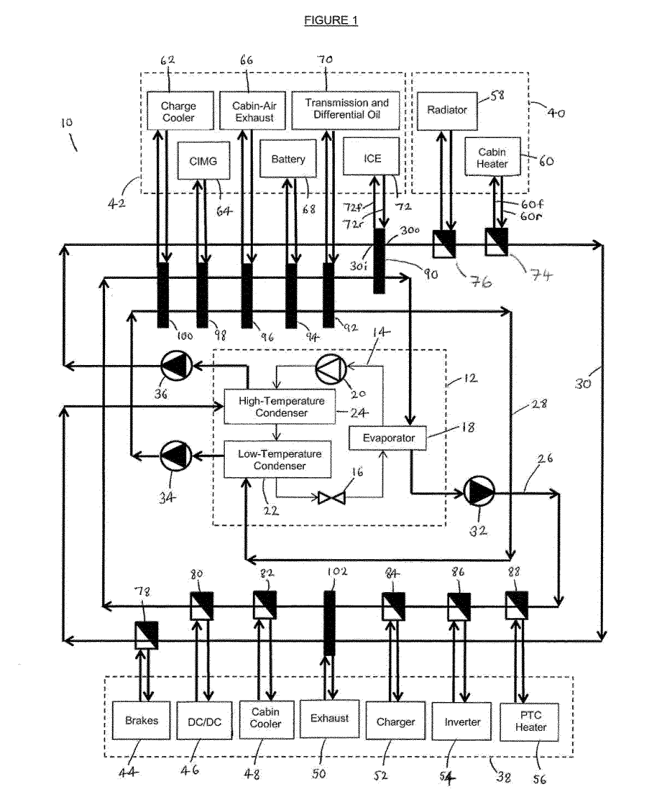

FIG. 1 shows one embodiment of a vehicle thermal energy distribution arrangement (VTEDA) 10 according to the invention. In particular, the VTEDA 10 comprises a heat-pump assembly or unit 12 with a unidirectional heat-pump (or refrigerant) path (or cycle) 14 comprising an expansion valve 16, an evaporator 18, a compressor 20, a (first) low-temperature condenser 22, and a (second) high-temperature condenser 24. First, second and third sections of the heat-pump assembly at first, second and third temperatures, respectively, comprise the evaporator 18, the first condenser 22, and the second condenser 24, respectively. The heat-pump path components 16-24 are arranged in a series configuration via line 14 suitable for transporting a refrigerant fluid. Alternatively the low-temperature condenser 22 and the high-temperature condenser 24 may be arranged in parallel configuration. The refrigerant may be, for example, R143a or R1234yf. Other types of refrigerant may also be useful. In another embodiment, the heat-pump path 14 may additionally include an accumulator (not pictured) for storing thermal energy and/or an intermediate heat exchanger or other performance enhancing device. Since the direction of flow in the heat-pump path 14 is unidirectional, then the heat-exchangers 18, 22, 24 may be optimised to perform a single function; that is, for example, the shape and orientation of heat exchanger 18 may be optimised to evaporate refrigerant fluid (i.e. a dedicated evaporator) and the shape and orientation of heat exchangers 22, 24 may be optimised to cool refrigerant gas or cool refrigerant fluid below condensing temperatures (i.e. dedicated condensers).

There are three thermal energy distribution paths or loops 26, 28, 30, where a thermal energy distribution path is a line or conduit containing a carrier fluid or coolant such as, for example, a water-ethylene-glycol mix. Each heat exchanger in the heat-pump path 14 (that is, evaporator 18, first condenser 22 and second condenser 24) is connected to one of the thermal energy distribution paths 26, 28, 30, respectively. These are referred to as the “cold” path 26, the “warm” path 28, and the “hot” path 30. Unlike in a reversible heat-pump assembly, each thermal energy distribution path 26, 28, 30 does not need to transport carrier fluid at a wide range of temperatures. In this case, each thermal energy path 26, 28, 30 is optimised to transport carrier fluid only in an appropriate relatively narrow controlled range of temperatures, for example, by forming each thermal energy path 26, 28, 30 of a material that maximises efficiency when transporting carrier fluid at a particular temperature. The thermal energy paths 26, 28, 30 are formed in actuality as a bundle or bundles of pipes flowing to appropriate locations in the vehicle.

The thermal energy distribution paths 26, 28, 30 each include a circulation pump (32, 34 and 36, respectively), and are located in series immediately after each respective heat exchanger 18, 22, 24, respectively.

FIG. 1 also shows a plurality of vehicle components that may draw thermal energy from, or reject thermal energy to, the thermal energy distribution paths 26, 28, 30 at different times throughout a vehicle journey, the components being split into three sets 38, 40, 42 representing components that are “energy sources” only, “energy sinks” only, and both energy sources and energy sinks, respectively.

An energy-source component is a component that rejects thermal energy to one of the thermal energy distribution paths 26, 28, 30 of the VTEDA 10, which may then be distributed to another component as needed. Energy-source components may be, for example, vehicle brakes 44, a DC-to-DC converter 46, a cabin cooler 48, a vehicle exhaust 50, a charger 52, an inverter 54, and a positive temperature coefficient (PTC) heater 56.

An energy-sink component is a component that draws thermal energy from one of the thermal energy distribution paths 26, 28, 30 of the VTEDA 10. Energy-sink components may be, for example, a radiator 58 and a cabin heater 60.

Energy source and energy sink components may function as either an energy source or an energy sink at different stages of a vehicle journey. Components that may function as both energy sources and energy sinks are, for example, a charge cooler 62, a crankshaft integrated motor generator (CIMG) 64, cabin-air exhaust 66, a battery 68, transmission and differential oil 70, and an ICE 72.

Each component may be switched into or out of one or two of the thermal energy distribution paths 26, 28, 30. A component that may be switched into or out of one thermal energy distribution path only is selectively connectable to that path via actuation of an on/off hydraulic control valve. For example, the cabin heater 60 is selectively connectable to the hot path 30 via actuation of an on/off control valve 74. In particular, if valve 74 is actuated to a first (off) configuration then the carrier fluid in the hot path 30 flows through the valve 74 without traversing the cabin heater 60. If, however, valve 74 is actuated to a second (on) configuration then the carrier fluid in the hot path 30 flows through the feed line 60f, traverses the cabin heater 60, and flows back through the return line 60r to the hot path 30. High-temperature thermal energy is thereby dissipated from the carrier fluid in the hot path 30 to the cabin heater 60. Valves 76-88 are also on/off hydraulic control valves. It may also be useful to use variable valves that may be actuated to intermediate configurations whereby only a prescribed proportion of the carrier fluid in a particular path traverses a particular component.

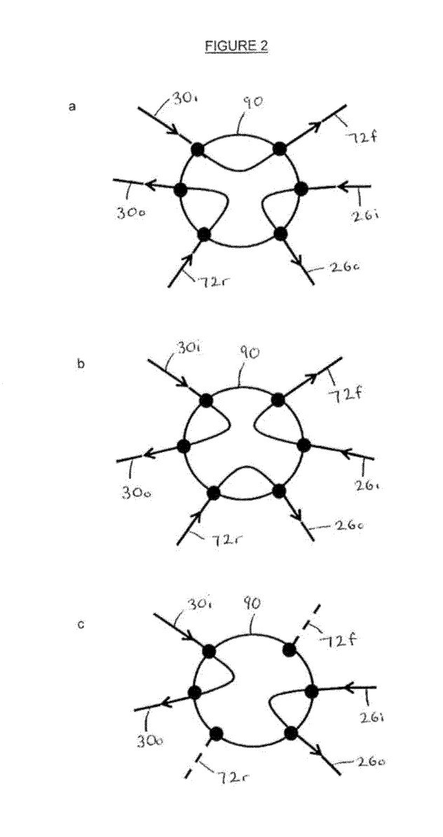

A component that may be switched into or out of two different thermal energy distribution paths is selectively connectable to a particular path via actuation of a six-port hydraulic valve. For example, the ICE 72 is selectively connectable to the hot path 30 or to the cold path 26 via actuation of a six-port valve 90. FIGS. 2a, 2b, 2c show a schematic representation of three possible configurations of the six-port valve 90. The valve 90 may be actuated between these three configurations. In particular, FIG. 2a shows a first configuration whereby carrier fluid in the hot path 30 traverses the ICE 72 but carrier fluid in the cold path 26 does not. Specifically, the input line 30i of the hot path 30 is connected to the feed line 72f to the ICE 72, and the return line 72r of the ICE 72 is connected to the output line 300 of the hot path 30. In addition, the input line 26i of the cold path 26 is connected to the output line 260 of the cold path 26. High-temperature thermal energy is thereby dissipated from the carrier fluid in the hot path 30 to the ICE 72 while no thermal energy is dissipated from the carrier fluid in the cold path 26 to the ICE 72.

FIG. 2b shows a second configuration whereby carrier fluid in the cold path 26 traverses the ICE 72 but carrier fluid in the hot path 30 does not. Specifically, the input line 26i of the cold path 26 is connected to the feed line 72f of the ICE 72, and the return line 72r of the ICE 72 is connected to the output line 26o of the cold path 26. In addition, the input line 30i of the hot path 30 is connected to the output line 300 of the hot path 30. Low-temperature thermal energy is thereby dissipated from the carrier fluid in the cold path 26 to the ICE 72 while no thermal energy is dissipated from the carrier fluid in the hot path 30 to the ICE 72.

FIG. 2c shows a third configuration whereby no carrier fluid traverses the ICE 72. Specifically, the input line 30i of the hot path 30 is connected to the output line 300 of the hot path 30, and the input line 26i of the cold path 26 is connected to the output line 26o of the cold path 26. Valves 92-102 are also six-port hydraulic valves. It may also be useful to use variable valves to be actuated to intermediate configurations whereby only a prescribed proportion of the carrier fluid in a particular path traverses a particular component.

The inclusion of two condensers 22, 24 in the heat-pump path 14, each connected to a different thermal energy distribution path 28 or 30, respectively, allows different components to be heated to different temperatures, as appropriate. For example, at the start of a vehicle journey in cold temperatures, the ICE 72 may need to be provided with a relatively large amount of heat and so may be switched into the hot path 30. The battery 68 may also need to be provided with heat; however, it may need to be provided with less heat than the ICE 72 and so may be switched into the warm path 28 instead. Thermal energy is thus not wasted where it is not needed, thereby improving the efficiency of the system.

As mentioned above, the system illustrated in FIGS. 1 and 2 may be used not only to dissipate or reject thermal energy from the thermal energy distribution paths 26, 28, 30 to the components in component sets 38, 40, 42, but also to collect or draw thermal energy from the components in component sets 38, 40, 42 into the thermal energy distribution paths 26, 28, 30 and therefore into the heat-pump path 14. This means that heat may be being drawn from one component of the vehicle at the same time as heat may be being rejected to another. For example, the brakes 44 may be connected to the hot path 30 and the battery 68 connected to the warm path 28. Thermal energy transferred from the brakes 44 to the hot path 30 is circulated back into the heat-pump path 14 and may then be used to heat the battery 68 via the warm path 28. Alternatively, the thermal energy drawn from the brakes 44 may be stored for later use as needed. In a further alternative, for example, the brakes 44 and the cabin heater 60 may both be switched into the hot path 30, and thermal energy drawn from the brakes 44 may directly be dissipated to the cabin heater 60.

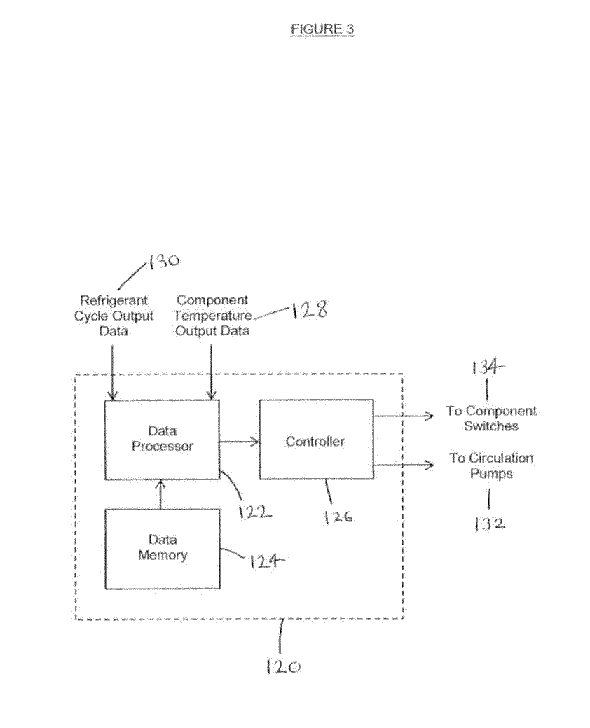

FIG. 3 shows a vehicle control system (VCS) 120 for automatically controlling the operation of the VTEDA 10 described above. The VCS 120 comprises a data processor 122, a data memory 124, and a controller 126. Each component in the VTEDA 10 comprises an arrangement of one or more temperature sensors (not pictured), and output data 128 from these temperature sensors is input to the data processor 122. Output data 130 from a temperature sensor to detect the amount of available thermal energy in the heat-pump assembly (or refrigerant cycle) 12 at any given time is also input to the data processor 122. Output data from other vehicle sensors may also be useful. The data processor 122 communicates with the data memory 124 to retrieve pre-determined data relating to, for example, the optimum operating temperature of a given component and an order of priority for heating or cooling different components. The data processor 122 sends a signal to the controller 126 which then sends signals 132, 134 to actuate the circulation pumps 32, 34, 36 and the valves (or switches) 74-102 connecting the components in component sets 38, 40, 42 to the thermal energy distribution paths 26, 28, 30, as appropriate, given the needs of the components in component sets 38, 40, 42 and the availability of thermal energy in the system at any given time. For example, at vehicle start-up both the ICE 72 and the cabin heater 60 may need to be provided with thermal energy. If the amount of thermal energy available is not sufficient to heat both of these components then the VCS 120 may prioritise the ICE 72 and first switch the ICE 72 into the hot path 30 via valve 90 so that all of the available thermal energy is directed here. Once the ICE 72 is sufficiently heated then the VCS 120 may switch the cabin heater 60 into the hot path 30. The VCS 120 controls the temperature of the carrier fluid in each thermal energy distribution path 26, 28, 30 by adjusting the flow rate in each path via actuation of the circulation pumps 32, 34, 36.

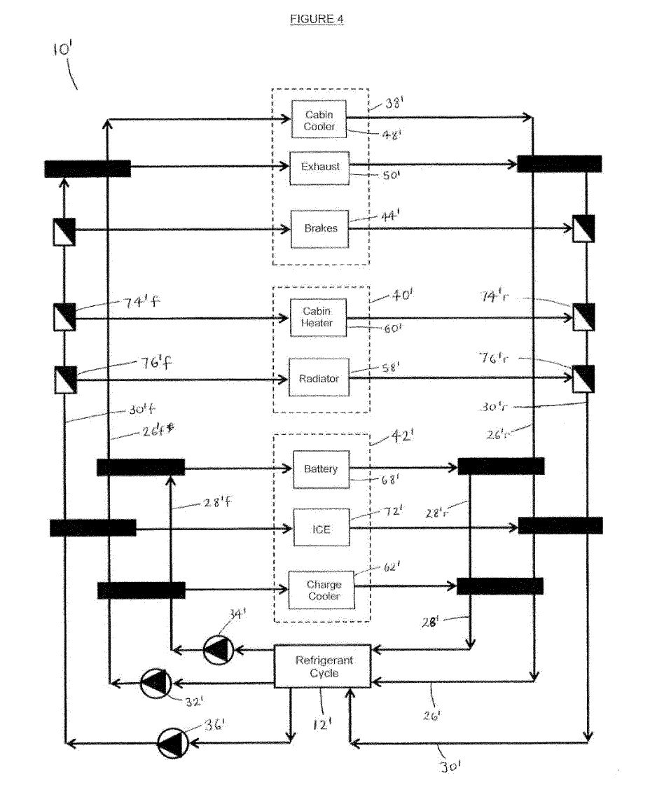

FIG. 4 shows another embodiment of a VTEDA 10′ according to the invention. In particular, the VTEDA 10′ comprises the unidirectional heat-pump assembly 12′ as in FIG. 1 (but shown here in less detail). There are three thermal energy distribution paths 26′, 28′, 30′, each connected to one heat exchanger in the heat-pump path 14′ (not pictured) as in FIG. 1. The thermal energy distribution paths 26′, 28′, 30′ each include a circulation pump (32′, 34′ and 36′, respectively), located in series immediately after each respective heat exchanger. FIG. 4 also shows three sets of vehicle components 38′, 40′, 42′, as in FIG. 1, representing components that are “energy sources” only, “energy sinks” only, and both energy sources and energy sinks, respectively. Each vehicle component 44′-72′ is selectively connectable to one or two thermal energy distribution paths 26′, 28′, 30′ via an on/off hydraulic control valve, a six-port hydraulic valve, a variable valve, or another type of valve, as described above.

The VTEDA 10′ in FIG. 4 differs from the VTEDA 10 in FIG. 1 in that the thermal energy distribution paths 26′, 28′, 30′ comprise feed lines 26′f, 28′f, 30′f flowing from the heat-pump assembly 12′ to the components 44′-72′ and return lines 26′r, 28′r, 30′r flowing from the components 44′-72′ to the heat-pump assembly 12′. This means that any given so-called “fluid packet” may traverse a single component 44′-72′ only between flowing out of the heat-pump assembly 12′ via feed line 26′f, 28′f or 30′f and returning to the heat-pump assembly 12′ via return line 26′r, 28′r or 30′r. In the VTEDA 10 in FIG. 1, if two or more components are switched into the hot path 30 to be heated at the same time, for example, then the temperature of the carrier fluid entering each component will progressively decrease since thermal energy is dissipated as each component is traversed. In the VTEDA 10′ in FIG. 4, however, if two or more components are switched into the hot path 30′ to be heated at the same time then the temperature of the carrier fluid entering each component may be kept constant by appropriate actuation of the relevant valves. For example, if the radiator 58′ and cabin heater 60′ are to be heated at the same levels then the feed valve 76′f may be actuated by VCS 120 in FIG. 3 to direct an appropriate proportion of the flow to the radiator 58′, while the remaining carrier fluid is directed to feed valve 74′f, which in turn directs it to the cabin heater 60′. Once the carrier fluid has traversed the radiator 58′ and cabin heater 60′ the return valves 76′r, 74′r respectively direct the carrier fluid back to the heat-pump assembly 12′ (i.e. no further components are traversed by the carrier fluid exiting the components 58′, 60′).

Note that fewer individual components are shown in FIG. 4 than in FIG. 1, but it is to be understood that as many or as few components as needed may be included in VTEDA 10 or 10′.

Note also that the above-described arrangements may comprise fewer or greater than three thermal energy distribution paths and fewer or greater than three heat exchangers in the heat-pump path.

1. A vehicle arrangement for drawing thermal energy from and/or rejecting thermal energy to a plurality of components in a vehicle, the arrangement comprising:
a heat-pump assembly comprising a first heat-pump section at a first temperature and a second heat-pump section at a second temperature different from the first temperature;
a first thermal energy distribution path for transporting a first carrier fluid and extending through at least a portion of the first heat-pump section, and a second thermal energy distribution path for transporting a second carrier fluid and extending through at least a portion of the second heat-pump section;
a first circulation pump associated with the first thermal energy distribution path for pumping the first carrier fluid around the first thermal energy distribution path and a second circulation pump associated with the second thermal energy distribution path for pumping the second carrier fluid around the second thermal energy distribution path; and
means for selectively connecting at least one of the plurality of vehicle components to at least one of the thermal energy distribution paths so as to draw thermal energy from and/or reject thermal energy to said vehicle component or components.

2. A vehicle arrangement according to claim 1, wherein the first heat-pump section comprises a dedicated evaporator and/or the second heat-pump section comprises a dedicated condenser.

3. A vehicle arrangement according to claim 1, the heat-pump assembly comprising: a third heat-pump section at a third temperature different from the first and second temperatures; a third thermal energy distribution path for transporting a third carrier fluid and extending through at least a portion of the third heat-pump section; and a third circulation pump associated with the third thermal energy distribution path for pumping the third carrier fluid around the third thermal energy distribution path.

4. A vehicle arrangement according to claim 3, wherein the third heat-pump section comprises a dedicated condenser.

5. A vehicle arrangement according to claim 1, the heat-pump assembly comprising a heat-pump path for transporting a refrigerant fluid, wherein the heat-pump path extends through the heat-pump sections.

6. A vehicle arrangement according to claim 1, the heat-pump assembly further comprising an accumulator for storing thermal energy.

7. A vehicle arrangement according to claim 1, wherein the heat-pump assembly is hermetically sealed.

8. A vehicle arrangement according to claim 1, wherein the means for selectively connecting at least one of the plurality of vehicle components to at least one of the thermal energy distribution paths includes at least one valve device.

9. A vehicle arrangement according to claim 8, wherein the at least one valve device is a hydraulic valve device.

10. A vehicle arrangement according to claim 8, wherein the at least one valve device is an on/off control valve.

11. A vehicle arrangement according to claim 8, wherein the at least one valve device is a six-port valve for selectively connecting a vehicle component to one of two of the thermal energy distribution paths.

12. A vehicle arrangement according to claim 8, wherein the at least one valve device is a variable valve device for allowing only a proportion of the flow in one of the thermal energy distribution paths to traverse at least one vehicle component.

13. A vehicle arrangement according to claim 1, wherein at least one thermal energy distribution path is for transporting a different carrier fluid from at least one other thermal energy distribution path.

14. A vehicle arrangement according to claim 1, wherein at least one thermal energy distribution path comprises a feed line and a return line.

15. A system for controlling the vehicle arrangement of claim 1, the system comprising:
means configured to receive sensor output data from at least one vehicle sensor;
means configured to store pre-determined data relating sensor output data from the at least one vehicle sensor to a particular configuration of the vehicle arrangement;
means configured to compare the sensor output data with the pre-determined data; and
means configured to send at least one control signal to actuate the means for selectively connecting at least one of the plurality of vehicle components to at least one of the thermal energy distribution paths, and/or to actuate at least one of the circulation pumps, in dependence on said comparison.

16. A system according to claim 15, wherein the at least one vehicle sensor is a vehicle component temperature sensor.

17. A system according to claim 15, wherein the at least one vehicle sensor is a heat-pump assembly temperature sensor.

18. A method for controlling the vehicle arrangement of claim 1, the method comprising:
receiving sensor output data from at least one vehicle sensor;
storing pre-determined data relating sensor output data from the at least one vehicle sensor to a particular configuration of the vehicle arrangement;
comparing the sensor output data with the pre-determined data; and
sending at least one control signal to actuate the means for selectively connecting at least one of the plurality of vehicle components to at least one of the thermal energy distribution paths, and/or to actuate at least one of the circulation pumps, in dependence on said comparison.

19. A non-transitory data memory containing a computer readable code for performing the method according to claim 18.

20. A vehicle comprising an arrangement according to claim 1.

21. A vehicle comprising a system or controller according to claim 15.

22-25. (canceled)
